(19) United States
(12) Patent Application Publication
(10) Pub. No.: US 2022/0035910 A1
(43) Pub. Date: Feb. 3, 2022

(54) SECURITY DETECTION ANALYTICS

(71) Applicant: Hewlett-Packard Development Company, L.P., Spring, TX (US)

(72) Inventors: Daniel Ellam, Bristol (GB); Adrian John Baldwin, Bristol (GB); Jonathan Griffin, Bristol (GB); Stuart Lees, Bristol (GB)

(73) Assignee: Hewlett-Packard Development Company, L.P., Spring, TX (US)

(21) Appl. No.: 17/299,656

(22) PCT Filed: Dec. 19, 2018
(86) PCT No.: PCT/US2018/066504

§ 371 Date: Jun. 3, 2021

(51) Int. Cl. G06F 21/55

(52) U.S. Cl. CPC G06F 21/554; G06F 2221/034

(57) ABSTRACT

Apparatus and methods to process received results of an analytical process performed on first external data at a first computer at a server, to obtain sensitizing data; and provide the sensitizing data from the server to a second computer for use in performing a sensitized analytical process on second external data received at the second computer.

### BACKGROUND

Computers may run analytical processes to process input data. For example, a computer may run an analytical process to determine whether a program should be downloaded to the computer or installed on the computer. For example, a computer may run an analysis to determine whether the program is a genuine safe item of software, whether the program contains some malicious code or malware, or whether legitimate software is being used for malicious purposes. Malicious code and code used for malicious purposes can prevent the computer from operating correctly, or at all, and may compromise the security of the computer allowing it to be used to malicious purposes (e.g. spreading viruses to other computers or mining password or banking data from the computer to provide to cyber-criminals).

### BRIEF INTRODUCTION OF THE DRAWINGS

Various features of the present disclosure will be apparent from the detailed description which follows, taken in conjunction with the accompanying drawings, which together illustrate features of the present disclosure, and wherein:

FIG. 1 shows a schematic representation of obtaining sensitizing data according to examples of the disclosure;

FIGS. 2a and 2b show schematic representations of sensitizing an analytical computer process according to examples of the disclosure;

FIG. 3 shows a schematic representation of an apparatus according to examples of the disclosure;

FIGS. 4a and 4b show schematic representations of sensitizing an analytical computer process according to examples of the disclosure;

FIG. 5 shows an example method according to examples of the disclosure; and

FIG. 6 shows an example method according to examples of the disclosure.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

A computer (which may be called an “endpoint”, “endpoint device”, “detector” or “security detector”) at the edge of an edge computing network may run behavioural analytics (which may be called an “edge analytic”). Such analytics, may, for example, analyse the behaviour taking place at the computer and determine, for example, a current risk of malware attack, or the chance of a security breach. Such an analytic may have various parameters and thresholds which it uses to make a decision about input data. This decision can be improved when knowledge about the broader context is included.

Edge-based computers may provide advantages over purely cloud-based or central-server based networks. However, due to their location at the edge of a computing network, they may make decisions regarding potential cyber threats and malware without the context of other devices' activity. Also, edge-based computers may generally lack the broader context about what other devices are seeing. This can be important when making security decisions such as malware detection and response.

Using data and findings from a wider context to analyse data at an edge computer may be called “sensitization”. Parameters and thresholds obtained based on analytical findings from other computers in the network may help improve the decision making by the edge computer. So, while the broader context information from other computers in the network is not necessary for an edge computer to make decisions, using it in analytics at an edge computer may improve results because the broader context of what is happening at other computers in the network is taken into account.

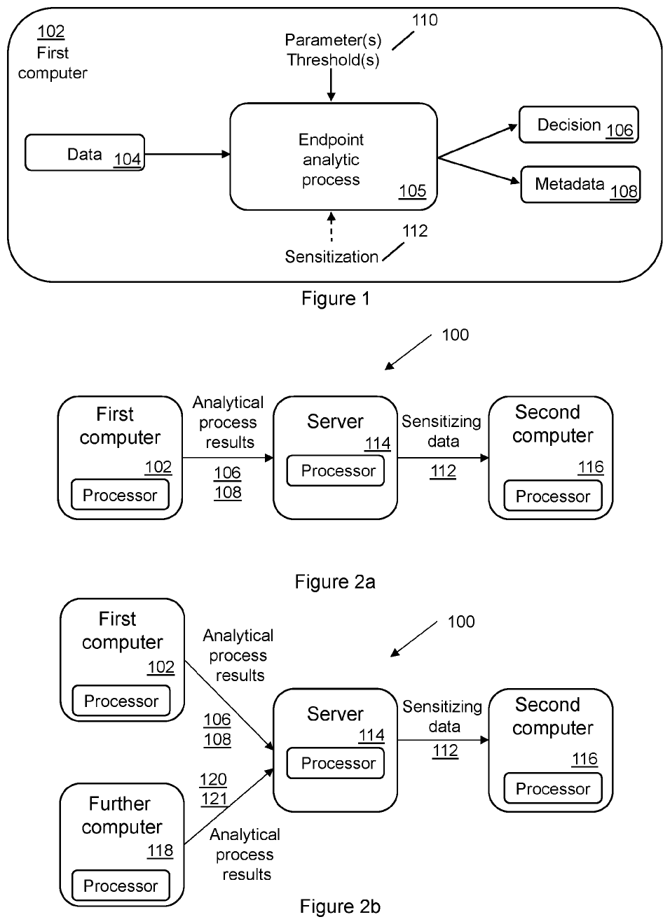

FIG. 1 illustrates an example computer 102 (an “endpoint device”) performing an analysis 105 of input data 104. Given an input 104, the computer 102 performs some analysis 105 on the input and produces a decision 106 (such as “good”, “bad”, “unknown”, or some likelihood score in [0,1], for example). The analysis 105 may be termed an “endpoint analytical process” 105, because the analysis is taking place on an endpoint device 102 (i.e. an edge computer 102). The decision, in turn, may lead to some action (such as “block, “allow”, “collect more data”, etc.). In addition, the computer 102 may produce some additional data about the detection which may be termed “metadata” 108. An example of metadata include timestamps at which the activity in question occurred. That is, the results of the analytical process 105 performed on data 104 (which may be termed “first external data”) at the first computer 102 may comprise metadata 108 indicating supplementary information related to the decision 106.

The term “external data” 104 may be understood to mean data at the first computer 102 which is related to an external influence, such as data received by a computer separate from and in communication with the first computer 102. External data 104 may comprise, for example: network data (e.g. domain name system (DNS) data and HTTP(S) data); host-based data (e.g. process, service & registry activity, file system access data, and peripheral access data (e.g. Operating System (OS) Application Programming Interface (API) calls)); process and thread creation and library data (dynamic-link library, dll) loading; files that are created, downloaded or changed; system calls made by a process; and CPU, memory and system resource usage statistics for a process.

The computer 102 may perform the analysis by taking into account the results of a different computer's analysis, which may be termed “sensitization” data 112. Obtaining this sensitization data is discussed in more depth below.

One way to address the issue of a computer performing analysis without the context from other computers in the network is by collecting device data from the computer (as well as from other computers in the network) into a common location and performing much of the analysis there. The common location may be a central server, or the Cloud. However, in an edge computing environment, collecting the data to a central common location may forfeit benefits of using edge-based detection. Possible benefits of using edge-based detection include the possibility of obtaining and analysing more data than would be sent back to a central server or clouds for central processing; an ability to respond more quickly to potential threats; an ability to respond when there is no connection available to the cloud (in other words, not relying on an “always-on” central computer for processing); and an edge-based computing system is scalable, in that local devices have their own processing power (centralising analytical processing on the cloud for a vast fleet of devices may take place using many servers at the cloud).

Further, the analysis at one computer may be improved by taking into account the findings of analysis from other computers in the network to take account of the broader context of the computer and the input data being received there. An example of broader context includes any related activity on other endpoints/computers. For example, if new behaviours are detected on a given endpoint, it would be useful to know, for example, if other devices are seeing this as new behaviour as well, or if this is an established pattern of behaviour for them.

As another example, taking into account the analysis from other computers may allow for the correlation of findings from the analysis computer with broader contextual information about the activity. The broader context may be obtained through enrichment lookups to, say, threat intelligence feeds or other records.

It may be undesirable and impractical to allow endpoint computers to perform enrichment lookups to (sometimes external) services. Doing so would consume resources of the computer, and may raise additional considerations regarding access control, authentication, licensing of information, and firewalling. It may in some cases be impractical to allow endpoints to communicate directly with each other as it may increase computational overheads, may involve the processing burden of mutual authentication and access control, and may raise issues regarding firewalling. It may also be difficult to share (anonymized) information from other organizations directly between endpoints.

Examples disclosed herein provide methods and devices which may address one or more of the above-mentioned challenges concerning edge computers performing analytics with the benefit of a broader context but reducing potential problems associated with accessing external enrichment sources or performing the majority of analysis at a centralised facility.

Examples disclosed herein may be implemented using machine learning. In machine learning terminology, the parameters and thresholds used in running analytical checks on input data may be called a “decision boundary”, which is a function of the data's features, learnt parameters and chosen model hyperparameters. Further, in a machine learning setting, the parameters 110 and sensitised data 112 may be feature vectors.

Examples disclosed herein may relate to propagating information derived from security detectors (computers, such as a PC, printer, or loT device) which are “on the edge” to its peers (a second computer, again such as a PC, printer, or IoT device) to help them to make more informed, accurate decisions on their own observed behaviour. Examples disclosed herein may be considered to relate to “alert metadata” generated at the edge (e.g. results of processing, data at the edge computer(s)). Such “alert metadata” is sent to a central server or servers (such as a cloud for cloud computing). Additional computations may be performed at the central server. In some examples, extra data e.g. from enrichment sources, may be gathered and added to the metadata. The resulting sensitization data may then be sent down and received by other devices which in turn may store and/or process the received sensitization data when running their own analytics. Such sensitization data may be used by the analytics running on the other devices, for example to alter inner parameters and thresholds based on the sensitization data. By collating analysis findings from one or more computers, and in some examples augmenting the findings with information stored at the central server, sensitization data may be distributed to other endpoint computers to allow improved “sensitized” analysis to take place there, benefitting from the information obtained from the other sources and/or from data stored centrally.

An analytic may be described by some function f. Then, mathematically, an example of the system of FIG. 1 may be expressed as:

(decision 106, metadata 108)=f(data 104, parameters 110, sensitization 112).

Examples disclosed herein may provide a way in which sensitizing data 112 can be curated from metadata 108 and distributed to other endpoints (a “second computer”) running analytics. The sensitizing data provides a context for the analysing computer, indicating knowledge of the context of the broader system, for example including what is happening across the general fleet of devices, in some examples with the context of external enrichment data and/or expert human analysis.

The decision 106 and metadata 108 can then be sent to a central server or cloud, where a corresponding routine may be performed to process the analytics' output. Here, the server/cloud can use the event metadata, content curated from human triage, and enrichment sources (which by design may not necessarily be available to endpoints) to adjust the sensitising parameters. Enrichment sources may include aggregated and anonymized metadata from similar detectors running in other organizations (i.e. cross-fleet enrichment).

FIGS. 2a and 2b show schematic representations of sensitizing an analytical computer process according to an example of the disclosure. FIG. 2a shows a first computer 102 which can perform an analytical process on first external data received at the first computer 102. An analytical process may perform some analysis on data received at a first computer/endpoint, to determine some measure of how “safe” (i.e. how indicative of legitimate activity) the data is (or conversely, how likely the data is to relate to malicious behaviour/malware). Several scenarios are detailed in the examples discussed at the end of this disclosure, such as: augmenting data with a trusted ranking such an alexa rank number or Whois information; considering if there are second-level domains that are within the trusted ranking; calculating statistical distributions of the characters comprising each domain (e.g. n-grams) (said “domain” may be a computer DNS domain name such as a web domain); calculating statistical distributions of the timestamps or timestamp differences of the data; applications of learned models to the data; and determining occurrence numbers on e.g. a daily and historical basis.

The results from the analytical process 106, 108 are then provided to the server 114. The server may be the Cloud in some examples. The server 114 can process the received results 106, 108 to obtain sensitizing data. Sensitizing data 112 may be considered to represent the results of the analytical process which is used to provide a context for the received external data so that an improved judgement of the nature of the data (e.g. whether the data is safe or malicious) may be made by the receiving computer 116.

The server 114 can then provide the sensitizing data 112 to a second computer 116. The second computer 116 can now perform a sensitized analytical process on second external data received at the second computer in dependence on the received sensitization data 112. A sensitized analytical process may be considered to be an analysis on data received at a second computer/endpoint 116, based on the context provided by the sensitizing data 112, to determine some measure of how safe the data is (or conversely, how likely the data is to relate to malicious behaviour/malware). That is, the second computer 116 may receive some external data and may analyse it with the benefit and context of analysis performed at other computers in the computing environment, and in some examples with the benefit of other data enrichment performed at the server 114 (by way of the sensitizing data).

Thus, overall, the system 100 may perform a method comprising: receiving, at a server, results of an analytical process performed on first external data at a first computer, the results indicating a decision of a level of malicious computer behaviour at the first computer; processing the received results at the server to obtain sensitizing data; and providing, from the server, the sensitizing data to a second computer to perform a sensitized analytical process on second external data received at the second computer in dependence on the received sensitization data.

In the example of FIG. 2b, there is a first computer 102 and a further computer 118. In other examples there may be more than one further computer 118. For example, a system may comprise many (e.g. more than 10, more than 20, or more than 50) computers providing analytical process results to the server 114. In this example, the sensitizing data 112 used by the second computer 116 to perform an analysis of second external data is a result of the server 114 processing the results 106, 108 of an analytical process performed on first external data at the first computer 102, as well as processing results (in this example, a decision 120 and metadata 121) of a further analytical process performed on further external data at the further computer 118. That is, in some examples, performing the sensitized analytical process on the received second external data is in dependence on the received sensitization data 112, wherein the sensitizing data 112 results from the server 114 processing the results 106, 108, 120, 121 of the analytical process performed on the first external data at the first computer 102 and processing results of a further analytical process performed on further external data at a further computer 118.

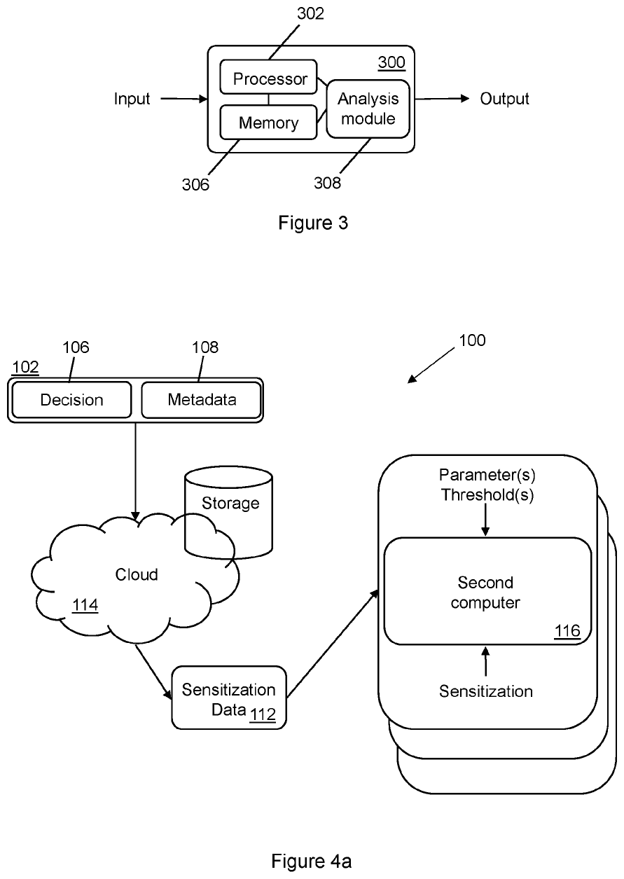

FIG. 3 shows a schematic representation of an apparatus according to an example of the disclosure. The apparatus comprises a processor 302; a computer readable storage 306 coupled to the processor; and an analysis module 308. An instruction set of the apparatus is to cooperate with the processor 302 and the computer readable storage 306. The apparatus 300 in some examples may be a first computer. The apparatus in some examples may be a second computer. The apparatus in some examples may be a further computer. The apparatus in some examples may be a central server. In some examples the apparatus 300 may be the computer. In some examples the apparatus may be a module for a computer.

In some examples, an apparatus such as that shown in FIG. 3 may be configured to receive sensitizing data from a server at an input. The sensitizing data is a result of the server processing results of an analytical process performed on first external data at a first computer. The sensitizing data indicates a level of malicious computer behaviour at the first computer. The apparatus can then perform a sensitized analytical process on received second external data in dependence on the received sensitization data. The analysis module 308 is to perform the analysis on external data (which may be sensitized if sensitizing data is available, but not necessarily be sensitized). Methods disclosed herein may be performed by an apparatus such as that of FIG. 3, comprising a processor 302, a computer readable storage (memory) 306 coupled to the processor 302, and an instruction set to cooperate with the processor 302 and the computer readable storage 306 to perform the methods.

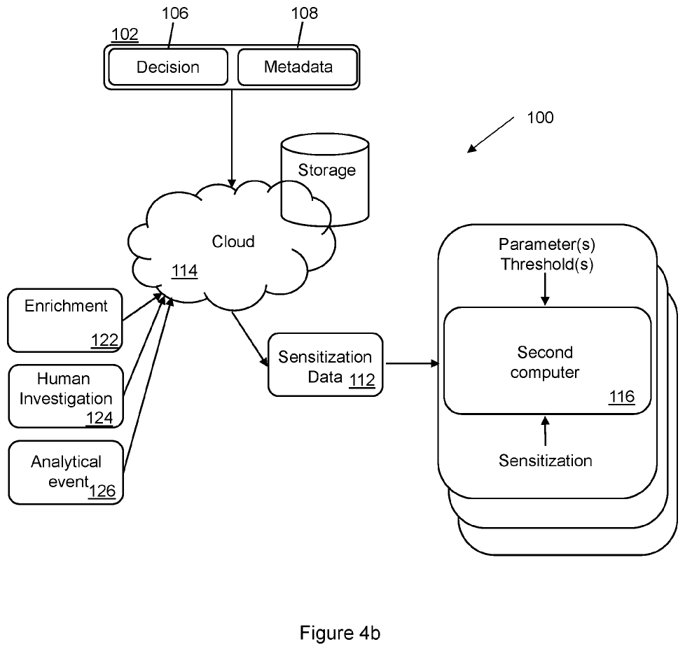

FIGS. 4a and 4b shows a schematic representation of sensitizing an analytical computer process according to examples of this disclosure. The second computer 116 in each example is to receive and process results of an analytical process performed on first external data at a first computer 102, wherein the results indicate a decision of a level of malicious computer behaviour at the first computer 102.

In FIG. 4a, processing the received results comprises determining to provide the received results as sensitizing data to the second computer. The sensitization data 112 is based on the findings from one (or more) computer(s) 102 analysing external data, and the analysis is provided to the server/cloud 114 to be passed on to the second computer 116. In the simplest case, no additional computation is performed at the server/cloud 114, which simply reflects the collected data 112 back to other endpoints 116. In this case, the sensitized data 112 would represent activity has been seen before elsewhere. The sensitized data 112 may, for example, feed into a parameter at the second computer 116 which considers whether the activity represented by external data received at the second computer 116 is new across the fleet.

FIG. 4a shows a first computer providing a decision 106 and metadata 108. In some examples there may be more than one first computer 102 (see FIG. 2b) so the results from the plurality of computers 102 providing decisions 106 and metadata 108 to the central server 114 may be collated to provide consolidated sensitization data 112 to the second computer 116. In some examples, there may be more than one second computer receiving the sensitization data 112 from the server/cloud 112. Metadata 108 may not necessarily be provided by the computer 102 (or in the example of a plurality of computers 102, by each computer of the plurality).

In FIG. 4b, processing the received results comprises analysing the received results to obtain the sensitizing data based on some external information 122, 124, 126 additional to the decision 106 obtained from the first computer 102.

Overall, decision data 106 and/or metadata 108 from one edge detector 102 may be used to sensitize the analytical processing at a different edge detector 116.

Such data sharing for analysis at different endpoints 116 is mediated by the central/cloud service 112.

For example, external enrichment data 122 may be used to provide a context of the received results. In some examples, the enrichment data 122 may comprise a threat intelligence feed indicating the presence of known malicious activity. In some examples, the enrichment data 122 may comprise an indication of a level of trust of a domain (i.e. a web domain) associated with the first external data processed at the first computer 102. As an example, data may be augmented by performing look ups, such as finding a domain's alexa rank, or its Whois registration data, as recorded in enrichment data 112. Searching blacklists and whitelists are other examples of using enrichment data 122 to supplement data 106, 108 analysis at the server/cloud 114. If the domain is alexa ranked (and thus may potentially be considered safe), the sensitized data 112 may indicate that an alert of malicious activity should be suppressed, thus avoiding a false positive indication, which may otherwise be indicated if the sensitized data 112, stating the domain is alexa ranked, were not available.

For example, human investigation 124 may be used to manually analyse the received results 106, 108 and supplement them to provide the sensitization data 112. For example, a data analyst (human) may manually insert a label or labels for external domain data which indicate(s): that the particular domain is associated with malware; that the particular domain is legitimate; and/or that a particular observed behaviour or activity should have a higher or lower weighting applied to it in considering whether activity is legitimate or malicious.

For example, data representing analysis 126 performed by a further computer may be used in an analytical process related to that performed by the first computer 102. That is, information may be calculated about events (e.g. alerts) associated with an individual device 102, or may be calculated about similar events taking place across the fleet of devices 102. Statistics 126 from a single device 102 may be taken over a longer time period (i.e. accounting for more than one instance of external data at a first computer 102), and/or data 126 across multiple devices 102 may be considered, when determining the sensitization data 112 at the server/cloud 114.

An example of analysed external data 126 may be details of command and control (C2) beaconing. A domain generation algorithm (DGA) edge analytic computer 116 may receive information in the sensitization data 112, due to external analysis 126, that C2 beaconing has/has not been observed to a given domain. For example, if potentially malicious beaconing to some-domain.com has been detected, then the DGA detector 116 may use this sensitized data 112 to decide to mitigate a DGA threat by triggering action after fewer observed events of relevance (such as indications of malicious activity) than if no such sensitized data was available to supplement the analysis performed at the analytic 116 alone.

Any one, or more than one, of these types of factors 122, 124, 126 may be used to analyse the received results and obtain the sensitizing data 112.

Such other external information or “deciding factors” can feed into the data 102 to supplement it and obtain sensitized data 112, so that the resultant sensitization data 112 provides context to the second computer 116 in relation to findings from other computers 102 in the network, as well as overall analysis based on external information available at the server/cloud 114 which may not be available at the end point computers. Thus the server/cloud 112 may perform some analysis based on the received decision(s) 106 and metadata 108, as well as on external factors 122, 124, 126, to obtain sensitization data 112. The sensitization data 122 provides context to be distributed to other endpoints 116 running the analytic. This sensitised data 112 may allow the other endpoints 116 to detect known malicious behaviours (as determined by the sensitized data) more quickly, or allow false positive indications of malicious activity to be suppressed. The sensitizing data may achieve this by indicating an adjustment to a parameter of the analytical process at the second computer, for example, to more quickly arrive at a decision regarding the analysed external data. The adjustment may thus provide for sensitization of the analytical process to be performed on the second external data at the second computer.

Further to detecting, for example, general domain generation algorithms (DGA) or command and control (C2) traffic more quickly, such examples may allow specific instances of (potentially malicious) behaviour to be more appropriately and more quickly acted upon.

In relation to FIGS. 4a and 4b, another example of action which may be performed in the server/cloud 114, for both fleet or single devices 116, is calculating statistical distributions and corresponding statistical measures on the data 106, 108, built up over time. For discrete data this may include frequency distributions. For continuous data measures such as the mean, or standard deviation, may be calculated. Such calculations may allow statistics and known distributions to be obtained of events such as alert information and distributions corresponding to ‘legitimate’ and ‘malicious’ activity. By observing how given events fits these different distributions may provide a way of performing some computation, such as an aggregation, on this data to produce a single score. The server/cloud 114 in some examples may make a direct decision and classify the contents of the events as corresponding to malicious, suspicious or legitimate based on such a score. Further, in some examples, known distributions may be imported (e.g. as enrichment data 122) to the server/cloud 114 for the same purpose. The results of such statistical calculations may be stored at the server/cloud 114. The server/cloud 114 may send such information or subsets of such information) to the endpoints as part of the sensitization data 112.

The above examples may provide a way of managing context data 106, 108, 122, 124, 126 by centralising, enriching and distributing. Upon distributing to other endpoints 116, the analytic 116 can now store and use the sensitized data 112 in making its decisions. Parts of the sensitized data 12 may be stored and used with other analytics on the endpoint.

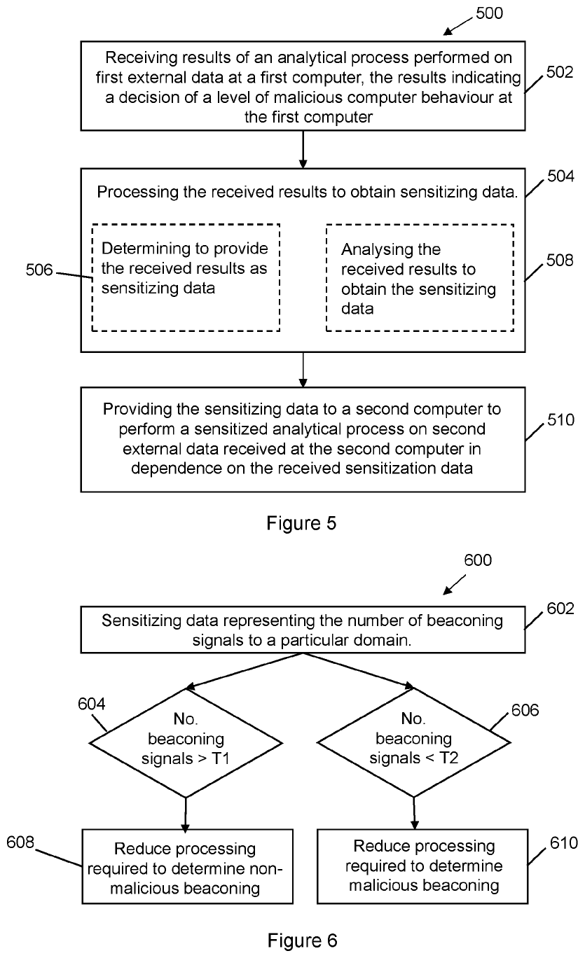

FIG. 5 shows an example method 500 according to examples of the disclosure. The method 500 comprises: receiving, at a server, results of an analytical process performed on first external data at a first computer, the results indicating a decision of a level of malicious computer behaviour at the first computer 502. Following receipt of the results the method 500 processes the received results at the server to obtain sensitizing data 504. The server then provides the sensitizing data to a second computer to perform a sensitized analytical process on second external data received at the second computer in dependence on the received sensitization data 510. Processing the received results in this example comprises determining to provide the received results as sensitizing data to the second computer 506 (see FIG. 4a), and analysing the received results to obtain the sensitizing data 508 based on: external enrichment data to provide a context of the received results; human investigation to manually analyse the received results; or data representing analysis performed by a further computer in an analytical process related to that performed by the first computer (see FIG. 4b). In certain examples, an element or elements of this example method may be omitted.

FIG. 6 shows an example method 600 according to examples of the disclosure. The sensitizing data in this example (for example, the sensitizing data obtained 504 from results of an analytical process at a first computer as shown in FIG. 5) represents a number of beaconing signals to a particular domain 602 (i.e. a web domain) including a beaconing signal to the particular domain from the first computer. If the sensitizing data represents a number of beaconing signals to the particular domain above a threshold T1 604 (that is, if a number of signals, e.g. regular communications to an address, above the threshold T1 is detected, these signals are considered to be beaconing signals), an adjustment is made to the sensitized analytical processing performed on the external data received at the second computer. The adjustment comprises reducing the sensitized analytical processing performed at the second computer to determine that the beaconing signals do not indicate malicious activity 608 if beaconing signals to the particular domain are received at the second computer.

If the sensitizing data represents a number of beaconing signals to the particular domain below a threshold T2 606, an adjustment is made to the sensitized analytical processing performed on the external data received at the second computer. The adjustment comprises reducing the sensitized analytical processing performed at the second computer to determine that the beaconing signals indicate malicious activity 610 if beaconing signals to the particular domain are received at the second computer.

In either case, whether the number of beaconing signals to a particular domain are above a threshold T1, or below a threshold T2, the reduction in sensitized analytical processing is reduced in comparison with non-sensitized analytical processing which would be performed at the second computer without the provided sensitizing data. In some examples T1=T2. In other examples, T1 may not equal T2.

In general, the sensitized analytical process performed at the second computer may be performed by adjusting a threshold in the sensitized analytical process compared with a threshold used in an analytical process without sensitization. The threshold may be associated with obtaining a decision whether or not the second external data processed at the second computer indicates malicious computer behaviour. Adjusting thresholds may allow for, for example, a decision whether external data is malicious or not to be made more quickly, or be made with a smaller data set of external data at the second computer that if no sensitizing data was available.

For example, the threshold adjustment may be adjusting the analysis time for the sensitized analytical process to obtain a decision of malicious behaviour at the second computer, compared with the analysis time for the analytical process without sensitization to obtain a decision of malicious behaviour at the second computer. The sensitization data may indicate that certain external data which was received at a first computer is related to malicious activity. Then, if comparable external data is received at the second computer, the second computer may perform a sensitized analysis of the external data, having the benefit of the analysis already performed at the first computer, and may thus reduce the analysis time to arrive at a conclusion that the external data represents malicious activity. The reduction in analysis time arises because comparable data analysed at the first computer has already been identified as potentially malicious, and the second computer benefits from this prior analysis at the first computer to make a decision more quickly about the malicious nature of the received external data.

Similarly, the threshold adjustment may be adjusting the number of indications of potentially malicious behaviour in the second external data for the sensitized analytical process to obtain a decision of malicious behaviour at the second computer, compared with the number of indications of potentially malicious behaviour in the second external data for the analytical process without sensitization to obtain a decision of malicious behaviour at the second computer.

In some examples, the sensitized analytical process performed at the second computer may comprise identifying that the processed second external data does not indicate malicious behaviour, compared with an analytical process without sensitization which would identify that the processed second external data indicates malicious behaviour. Such examples may be considered as avoiding “false positive” results. For example, external data may, if analysed alone (i.e. in isolation from analysis at a different computer, and from external information sources such as a list of trusted sites or a list of expected data updates) provide a result indicating that the data is potentially related to malicious behaviour. However, the data may not, in fact, relate to malicious behaviour.

For example, a software update may be released. This new software update information may be transmitted to a computer who, in the absence of any context or information about the data update, may treat the software update as potentially malicious data until extensively checked out. However, if the computer is able to perform a “sensitized analysis”, then the analysis may be performed more quickly compared with a non-sensitized analysis, and may reach a more correct conclusion of “non-malicious software update” as opposed to “potentially malicious attempt to modify software”. The sensitizing data used to perform the sensitized analysis may include analysis results from a separate computer (or a plurality of separate computers) which indicate that the data relates to a safe software update, and/or information from an external source such as the software supplier, indicating that a software update is due to be released (such as a “software release” list stored at a central server or Cloud). More than one sensitizing data source may be collated at a central server or Cloud before providing consolidated sensitization data to the second computer.

The following examples illustrate sensitizing analytical processes. The examples are organised into three steps, each of which roughly corresponds to a) the initial collecting and alerting on the endpoint 102, b) the enrichment at the cloud 114, and c) the delivering of the sensitized data 112 back to endpoints 116. Each step may contain multiple examples.

### EXAMPLE 1

Step 1: Alerting and Sending Alert Data

As an example, a device may collect domain name system (DNS) data and perform an analysis. When an alert is generated by the endpoint related to DGA activity, the event may produce additional metadata including (but not be limited to) the failed DNS lookups (the DNS queries returning non-existent domains (NXDOMAINS)), and the timestamps indicating when they occurred. In addition, new DNS lookups may be added, which succeed, but are previously unseen on the device after an alert of potential malicious behaviour has been triggered (hence possible DGA activity). This information may be denoted by {(domain1, result, timestamp1), (domain2, result, timestamp2), . . . , (domain_n, result, timestamp_n)} (and is an example of metadata 108), where the domain is the DNS domain, the timestamp is when the request happened and the result is a flag indicating whether it was successful or not.

Step 2: Augmenting, Aggregating and Scoring Alert Data in the Cloud

An alert may be triggered, and action may be taken immediately based on this information. However, such a decision lacks the context of, say, whether other devices are also seeing this activity or indeed whether this activity is established elsewhere in the organization. This information may impact the most appropriate action to take. In addition, there is no external information about the domains in question. Registration information, alexa rankings, and threat intelligence feeds, for example, can all be used to help make an assessment about the domains in question. In addition, more sophisticated and computationally expensive calculations may be applied at the cloud 114 than at an edge computer 116, in addition to being able to collect more data at the cloud 114.

For example above, each successful new domain may be augmented in the alert information domain_i with its alexa rank number and Whois information such as registration date. In this case, alert information now additionally contains some integer value, such as {(domain1, result, timestamp1, ALEXA_RANK), (domain2, result, timestamp2, ALEXA_RANK), . . . , (domain_n, result, timestamp_n, ALEXA_RANK)}. Further examples include considering if there are second-level domains that are within the alexa list or Whois information that can be obtained. For example, if a domain wrong.hp.com is received, information based on the hp.com second-level domain may be used to rank the likelihood that it could be generated as part of a DGA. As another example, <<some_dynamic_dns_provider.com>> could relate to DGA traffic because malware owners can register domains.

In addition, statistics may be calculated on the timestamps t_i (or their differences) to understand their distributions. It may be determined from the timestamps if, for example, the connections are periodic, or whether they occur at certain parts of the day. On the central server 114 more sophisticated calculations or learned models may be applied than at the edge 116, as well as possibly gathering extra information. Furthermore, statistics may be calculated on the distributions of the characters comprising each domain domain_i, such as n-grams. A similarity measure may be computed between domain names and those in the alexa rank lists to try to identify typing mistakes. Occurrences may be counted for each domain_i received across all the fleet on e.g. a daily and historical basis. That is, have those domains been seen in the past or are they being seen over multiple devices during the current day/week. Where there are similar domain_i names across multiple devices in the fleet, it may be checked whether they have similar time difference distributions. This may be obtained through analysing the timestamps in the alert information {(domainl, result, timestamp1), (domain2, result, timestamp2), . . . , (domain_n, result, timestamp_n)}. This data may be sent (either pull or push model) to other endpoints 116.

Step 3: Push/Pull Cloud Data to other Endpoints

In an example of the cloud receiving a list of domains, as enrichment data {(domain1, timestamp1), (domain2, timestamp2), . . . , (domain_n, timestamp_n)}, it may choose to do nothing and simply send (push/pull) the list of domains out to other endpoints which can then use this additional information (provided that they have been designed to integrate with this system). For example, the receipt of this domain information by the endpoint 116 may change the internal thresholds and other parameters used by the endpoint to assess activity related to the received external data {(domain1, timestamp1), (domain2, timestamp2), . . . , (domain_n, timestamp_n)}. Alternatively, the endpoints 116 may receive, along with the domains, the alexa rank of the domains. This may be stored and be used with another analytic involving domain names, such as determining the legitimacy of command and control beaconing activity, or assessing the risk of a potential drive by download attack. By sending the information to the endpoint 116 rather than making a decision in the cloud 114 and propagating the decision directly to the endpoints 116, each endpoint 116 is able to make a decision customized to its local environment and context (e.g., threat level or false positive rates configured by the local administrator).

In another example, the cloud 114 may do more processing of the data 106, 108 to create a score, or an interval for a score (upper and lower bound) to be sent to other endpoints 116. Here, the cloud 114 is instructing endpoints 116 on how to score the given alert information (i.e. score the second external data). This scoring information may be used by the analytic 116 to react appropriately. As another example, if a range is provided (min_score, max_score), then any analytic 116 seeing this alert information may use this as a guide, and create a finalized score taking into account this suggested score range as well as the received and analysed external data.

In another example, the cloud creates a simple classification for the alert information, such as “bad”, “warning” or “legitimate”. This may come from human intervention and investigation, or if there is a security advisory on a particular analytical process. This gives a clear indication to endpoints 116 how they should treat data generated by activity they see which matches the given alert information. In this case, if an endpoint 116 receives the following alert information from the cloud (which itself was received from an endpoint alert): {(domain1, timestamp1), (domain2, timestamp2), . . . , (domain_n, timestamp_n)} and is instructed to block any such activity, then the first occurrence of any of domain_i will be blocked by the endpoint 116. Consequently, alert information from one endpoint 102 has been used to make quicker decisions on another endpoint 116.

### EXAMPLE 2

### Sensitizing C2 Beaconing Detection

Step 1: Alerting and Sending Alert Data

A device 102 may collect Hyper Text Transfer Protocol (Secure) (HTTP(S)) data and perform an analytical method on the data. When an alert is generated by the endpoint 102 related to C2 activity, the event may produce additional metadata 108 including (but may not be limited to) the timestamps of the connections, HTTP header data such as response code, bytes sent/received, HTTP referrer, HTTP verbs used, user agents, and when the domain name was first visited by the endpoint, amongst others.

Step 2: Augmenting, Aggregating and Scoring Alert Data in the Cloud

Context is important when assessing the severity of beaconing traffic. In this example, each domain in the alert information may be augmented with its alexa rank number and Whois information such as registration date. Analysis may also be performed of any uniform resource locators (URLs) included in the beaconing. As examples, a check may be made whether the URLs appear to encode data. Analysis on the characters may be used to do this. The IP address of the hosting server may be geolocated. Occurrences may be counted on each domain received across all the fleet on a daily and historical basis. That is, have they been seen in the past or are they being seen over multiple devices during the current day/week. The first time the domain was visited across the entire fleet, or how many distinct sources visited the domain over a given time interval may be used as enrichment data to supplement the received data and provide context.

As examples, the timestamps involved in the beaconing may be analysed via clustering or another statistical technique. Other alert information where the patterns of activity were similar but with a different domain may be identified. This can help identify malware fluxing its C2 server. Other occasions on which the domain was seen across the fleet may be used to enrich the received external data. For example, if the domain was recently observed in SMTP records as being a link in an email, and if SMTP analytics are available, a risk score of that email may be used. This could indicate a potential phishing domain being reused as a C2 domain.

Such data, enriched by the context as determined above, may be sent (either pull or push model) as sensitizing data to other endpoints 116.

Step 3: Push/Pull Cloud Data to other Endpoints

An endpoint 116 may receive the sensitized data 112 as calculated from Step 2. It may use, for example, the fact that other devices 102, 118 have seen beaconing activity to a domain which it has now observed to influence its decision in the following way. If many other devices 102, 118 have beaconed to this server, then this could indicate a new update service rolled out or similar, and so a false positive finding of potentially malicious activity may be suppressed. Otherwise, if the domain was never, or rarely visited by a few sources very recently, a decision may be made to alert and action (e.g. block) traffic from that domain sooner rather than waiting for various thresholds to have been met since the recent behaviour related to that domain, as determined by other endpoints, suggests malicious activity.

As another example, the endpoints 116 may receive, along with the domain, the alexa rank of the domain. This may be stored and be used with another analytic involving domain names such as determining the legitimacy of a DNS lookup or assessing the risk of a potential drive by download attack. Statistics about timestamps may be received as part of the sensitized data 112. Here, if similar patterns of activity are being seen on the endpoint 116 (but for a different domain), this may lend weight to the assertion that the source is witnessing a fluxing C2 domain. This may include periodicity, duration, etc. If the observed user agent is different to that typically used by the source, and if this user agent is contained in the sensitized data as being potentially malicious, it may be decided to again block or take action more quickly.

In another example, the cloud 114 may do more processing of the data to create a score, or an interval for a score (upper and lower bound) to be sent to other endpoints. Here, the cloud is instructing endpoints how to score the given alert information. This can be used by the analytic to react appropriately. Equally, if a range is provided (min_score, max_score), then any analytic seeing this alert information uses this as a guide, and creates a finalized score taking into account this suggested score range.

In another example, the cloud 114 may create a simple classification for the alert information, such as “bad”, “warning” or “legitimate” as examples. This may come from human intervention and investigation, or if there is a security advisory on a particular analytic. This may also come from threat intelligence or a blacklist/whitelist and a flag in the sensitized parameters may be set to indicate this fact. This gives a clear indication to endpoints 116 how they should treat data generated by activity they see which matches the given alert information. In this case, if an endpoint receives the alert information from the cloud (which itself received it from an endpoint alert) about some-domain.com and is instructed to block any such activity, then the first connection to some-domain.com will be blocked by the endpoint 116, rather than wait for various other thresholds to be met. Consequently, alert information has been used from another endpoint, by way of sensitizing the analysis at the endpoint using sensitizing data from the cloud 114 which in turn is at least partly from a different endpoint 102, 118, to make quicker decisions on the endpoint 116.

In examples where third party applications and plug-ins are being installed on devices, there may be a greater variety and quantity of external network traffic from devices and thus more opportunities for vulnerabilities and malware to cause issues at networked devices. Thus the importance of being able to identify malicious behaviour and correctly identify behaviour as being non-malicious effectively increases. Being able to improve the detection of malicious and non-malicious behaviour, while taking advantage of the advantages of edge computing networks (e.g. the non-reliance of decentralised and edge computing network on a central computer and an increase speed of edge-based computers), while taking advantage of fleet-wide and cross-fleet threat detection, is important. Examples disclosed herein may help address such issues.

All of the features disclosed in this specification (including any accompanying claims, abstract, and drawings) may be combined in any combination, except combinations where some of such features are mutually exclusive. Each feature disclosed in this specification, including any accompanying claims, abstract, and drawings), may be replaced by alternative features serving the same, equivalent, or similar purpose, unless expressly stated otherwise. Thus, unless expressly stated otherwise, each feature disclosed is one example of a generic series of equivalent or similar features.

The present teachings are not restricted to the details of any foregoing examples. Any novel combination of the features disclosed in this specification (including any accompanying claims, abstract, and drawings) may be envisaged. The claims should not be construed to cover merely the foregoing examples, but also any variants which fall within the scope of the claims.

1. A method comprising:
receiving, at a server, results of an analytical process performed on first external data at a first computer, the results indicating a decision of a level of malicious computer behaviour at the first computer;
processing the received results at the server to obtain sensitizing data; and
providing, from the server, the sensitizing data to a second computer to perform a sensitized analytical process on second external data received at the second computer in dependence on the received sensitization data.

2. The method of claim 1, wherein the results of the analytical process performed on the first external data at the first computer comprise metadata indicating supplementary information related to the decision.

3. The method of claim 1, wherein processing the received results comprises determining to provide the received results as sensitizing data to the second computer.

4. The method of claim 1, wherein processing the received results comprises analysing the received results to obtain the sensitizing data based on :
external enrichment data to provide a context of the received results;
human investigation to manually analyse the received results; or
data representing analysis performed by a further computer in an analytical process related to that performed by the first computer.

5. The method of claim 4, wherein the enrichment data comprises:
a threat intelligence feed indicating the presence of known malicious activity; or
an indication of a level of trust of a domain associated with the first external data processed at the first computer.

6. The method of claim 1, wherein the sensitizing data indicates an adjustment to a parameter of the analytical process at the second computer, the adjustment providing for sensitization of the analytical process to perform on the second external data at the second computer.

7. The method of claim 6, wherein the sensitizing data represents a number of beaconing signals to a particular domain including a beaconing signal to the particular domain from the first computer; and wherein:
if the sensitizing data represents a number of beaconing signals to the particular domain above a threshold, the adjustment is to reduce the sensitized analytical processing at the second computer if beaconing signals to the particular domain are received at the second computer to determine that the beaconing signals do not indicate malicious activity; and
if the sensitizing data represents a number of beaconing signals to the particular domain below a threshold, the adjustment is to reduce the sensitized analytical processing at the second computer if beaconing signals to the particular domain are received at the second computer to determine that the beaconing signals indicate malicious activity;
the reduction in sensitized analytical processing being reduced in comparison with non-sensitized analytical processing which would be performed at the second computer without the provided sensitizing data.

8. The method of claim 1, wherein the analytical process performed on the first computer is the same as the non-sensitized analytical processing which would be performed at the second computer without the provided sensitizing data.

9. The method of claim 1, wherein the server is comprised in the Cloud.

10. An apparatus comprising:
a processor;
a computer readable storage coupled to the processor; and
an instruction set to cooperate with the processor and the computer readable storage to:
receive sensitizing data from a server, the sensitizing data resulting from the server processing results of an analytical process performed on first external data at a first computer, the sensitizing data indicating a level of malicious computer behaviour at the first computer; and
perform a sensitized analytical process on received second external data in dependence on the received sensitization data.

11. The apparatus of claim 10, wherein the instruction set is to cooperate with the processor and the computer readable storage to perform the sensitized analytical process by:
adjusting a threshold in the sensitized analytical process compared with a threshold used in an analytical process without sensitization, wherein the threshold is associated with obtaining a decision whether or not the second external data processed at the second computer indicates malicious computer behaviour.

12. The apparatus of claim 10, wherein the instruction set is to cooperate with the processor and the computer readable storage to adjust the threshold by:
reducing the analysis time or the number of indications of potentially malicious behaviour in the second external data for the sensitized analytical process to obtain a decision of malicious behaviour at the second computer, compared with
the analysis time or the number of indications of potentially malicious behaviour in the second external data for the analytical process without sensitization to obtain a decision of malicious behaviour at the second computer

13. The apparatus of claim 10, wherein the instruction set is to cooperate with the processor and the computer readable storage to perform the sensitized analytical process by:
identifying that the processed second external data does not indicate malicious behaviour, compared with an analytical process without sensitization which would identify that the processed second external data indicates malicious behaviour.

14. The apparatus of claim 10, wherein the instruction set is to cooperate with the processor and the computer readable storage to:
perform the sensitized analytical process on the received second external data in dependence on the received sensitization data, wherein the sensitizing data results from the server processing the results of the analytical process performed on the first external data at the first computer and processing results of a further analytical process performed on further external data at a further computer.

15. A non-transitory computer readable storage medium having executable instructions stored thereon which, when executed by a server, cause the server to:
process received results of an analytical process performed on first external data at a first computer, to obtain sensitizing data; and
provide the sensitizing data to a second computer for use in performing a sensitized analytical process on second external data received at the second computer.
